(19) United States
(12) Patent Application Publication
(10) Pub. No.: US 2010/0303618 A1
(43) Pub. Date: Dec. 2, 2010

(54) WIND POWER STATION WITH DARRIEUS-ROTOR

(75) Inventor: Robert Penn, Eichenau (DE)

Correspondence Address: MEYERTONS, HOOD, KIVLIN, KOWERT & GOETZEL, P.C., P.O. BOX 398, AUSTIN, TX, 78767-0398, US

(73) Assignee: Anneliese Penn, Eichenau (DE)

(21) Appl. No.: 12/548,919

(22) Filed: Aug. 27, 2009

(30) Foreign Application Priority Data
Jun. 2, 2009 (DE) 09161652.4
Jun. 2, 2009 (EP) 09161652.4

(51) Int. Cl. F03D 3/04

(52) U.S. Cl. 415/208.2

(57) ABSTRACT

The power output of a wind power station with a Darrieus Rotor is enhanced by wind guides positioned around the Darrieus Rotor to form a wind concentrator. The wind guides include at least two parallel wind deflection plates, displaced along parallel direction with respect to each other.

### PRIORITY CLAIM

This application claims priority to pending European Application No. 09161652.4 filed on Jun. 2, 2009.

### BACKGROUND OF THE INVENTION

1. Field of the Invention

The invention relates to a wind power station with a Darrieus Rotor and a wind concentrator formed by wind guides. The invention further relates to a wind guide for a wind concentrator of a wind power station with a Darrieus Rotor and to the respective wind concentrator.

2. Description of Related Art

A Darrieus Rotor is a rotor with at least one rotor blade. Typically a Darrieus Rotor includes two or three rotor blades. The rotor blade rotates around a vertical rotor axis. The horizontal cross section of the rotor blade has a foil shape. The torque provided by the rotor is due to the forward components of the lifting forces exercised by the wind on the foil shaped rotor blades. The longitudinal axis of the rotor blades is often parallel to the rotor axis, but can as well be inclined with respect to the rotor axis and/or the vertical.

A wind power station with a Darrieus Rotor and a wind concentrator is disclosed in DE-T2-692 20 857. The wind concentrator includes twelve wind guides that are arranged concentrically around the Darrieus Rotor. Each wind guide has a fixed position and the shape of a vertically extending symmetric air-foil. The planes defined by tip and tail of the wind guides intersect in the axis of rotation of the Darrieus Rotor. The wind concentrator enlarges the amount of wind that powers the Darrieus Rotor and where necessary deflects the wind in the direction of the rotor axis of the Darrieus Rotor. The wind concentrator is—so to speak—a wind lens focussing the wind on the rotor axis independently from the wind direction.

It is an object of the invention to improve the power retractable from a wind power station with a Darrieus Rotor and a wind concentrator.

### BRIEF SUMMARY OF THE INVENTION

In an embodiment the wind power station includes a Darrieus Rotor with a rotor axis and at least one rotor blade mounted at a distance from the rotor axis. This distance defines the radius of the Darrieus Rotor. Further the wind power station includes a wind concentrator. The wind concentrator includes an assembly of wind guides positioned around the Darrieus Rotor. At least one of the wind guides includes at least a first and a second wind deflector plate, the first and the second wind deflector plates being approximately parallel. Of course first and a second wind deflector plates can be arranged at any angle, the smaller the angle is the better, preferably the angle is smaller 10°, more preferably smaller 5° or 3°. Preferably each wind guide includes at least a first wind deflector plate and at least a second wind deflector plate, the first and the second wind deflector plates mounted at least approximately in parallel. The following description assumes that all wind guides each include at least two parallel wind deflector plates. But of course one corresponding wind guide is sufficient to enhance the retractable power.

The embodiments are based on the observation that the torque exercised by the wind on the foil shape rotor blade of the Darrieus Rotor has a maximum if the wind is inclined about 10° (depending on the foil shape, for typical foil shapes between about 5° and 20°) from the radial direction against the direction of the rotating rotor blade. This angle is called optimum angle. Without wind concentrator and with wind coming from the south the maximum torque is generated on a counter clockwise rotating rotor blade if the blade passes the 170° position (160° to 175° position, depending on the foil shape; 0° corresponds to the northern direction, positive angles are measured counter clockwise). The “slice” of wind blowing against the rotor blade when it passes this position has the optimum direction, because it blows against the rotor blade at the optimum angle. This slice is called “optimum slice”. The slices of wind that blow against the rotor left or right of the optimum slice, so called “non optimum slices”, are deflected to blow against the rotor in an angle that is closer to the optimum angle.

From the viewpoint of a wind guide the direction of deflection of wind blowing against the right side of the wind guide must be different from the direction of deflection of wind blowing on the left side of the wind guide. Thus, the directions of deflection of wind coming from the right and from the left of the wind guide are asymmetric with respect to the radial direction of the respective wind guide. The radial direction of each wind guide is defined by the vector from the respective wind guide to the rotor axis. Wind blowing against the wind guide in an angle smaller 0° and bigger equal −90° (positive angles open counter clock-wise) with respect to the radial direction is considered to blow against the wind guide from the left side and wind blowing against the wind guide in an angle bigger 0° and smaller equal 90° with respect to the radial direction is considered to blow against the wind guide from the right side. Further, if the respective wind guide is positioned in the optimum slice, e.g. because the wind turned, the wind should pass without deflection and essentially without slowing down due to the wind resistance of the wind guide

The asymmetric deflection with respect to the radial direction of the respective wind guide and the required transmissibility in the optimum direction is provided by the wind guide including at least a first wind deflector plate and a second wind deflector plate, the first and the second wind deflector plates being parallel. In one embodiment the wind deflector plates are displaced along parallel direction with respect to each other, e.g. the first wind deflector plate is mounted closer to the rotor axis than the second wind deflector plate.

In a further embodiment at least one of said first or second wind deflector plates has first edge and a second edge, the first and the second edges being in a virtual plane, and said virtual plane being parallel to said rotor axis in a distance bigger zero from the rotor axis. In other words the wind deflector plates are inclined against their respective radial direction. This permits mounting the wind deflector plates parallel to the optimum direction. Then the wind from the optimum direction passes the wind guide with low losses. Due to the channel(s) between the wind deflector plates turbulences are reduced, resulting in a higher torque. Further the wind guide has two different angles of deflection. Wind from other directions than the optimum direction is deflected into the optimum direction.

A first direction of deflection of wind guide is defined by the vector from the most windward edge of the wind deflector plates to the most leeward edge of the wind deflector plates of the respective wind guide. The wind is deflected in this first direction of deflection if the wind hits the respective wind guide such that the wind does not enter directly the channel(s) between the wind deflector plates of the respective wind guide. Briefly speaking, the wind is deflected as if the wind guide would be a single wall spanning from the windward edge of the wind guide to the leeward edge of the wind guide, although the wind guide is an assembly of at least two wind deflector plates. If the wind, however, hits the respective wind guide from the opposite side, i.e. such that it can enter into the channel(s) between the wind deflector plates, the direction of deflection is the direction of the parallel vectors from the windward edges to the respective leeward edges of each wind deflector plate. This is the second direction of deflection of the wind guide. The two directions of deflection can thus be chosen and adjusted according to the foil profile of the rotor blade by selecting the inclination of the wind deflector plates against the radial direction on the one hand and the displacement of the wind deflector plates in the radial direction together with the distance between the wind deflector plates on the other hand.

In a further embodiment the first wind deflector plate is mounted closer to the rotor axis than the second wind deflector plate.

In a further embodiment the wind deflector plates of the wind guides have the same size. This helps to keep costs for the wind guides low.

In a further embodiment the first and second wind deflector plates overlap, i.e. the first wind deflector plates include a first edge mounted at a first distance from said rotor axis and a second edge mounted at a second distance from said rotor axis. The first distance is shorter than said second distance. The second wind deflector plates include a third edge mounted at a third distance from the rotor axis, and a fourth edge mounted at a fourth distance from said rotor axis. Said third distance is shorter than said fourth distance. Said third distance is in between the first and second distances, i.e. it is longer than said first distance and shorter than or equal to said second distance.

In a further embodiment the wind guide further includes at least a third wind deflector plate which is parallel to the first and second wind deflector plates.

In a further embodiment the wind guides are placed symmetrically around the rotor axis to improve the retractable power from the wind power station independent of the wind direction. There is no need to rotate the wind concentrator to adjust it according to the wind direction.

In a further embodiment the positions of the wind guides are fixed. This helps as well to keep costs low.

The angle of inclination against the radial direction of at least a subset of the wind deflector plates may in a further embodiment as well be adjustable, e.g. by pivoting the wind deflector plates. This permits to reduce the effective wind in case of storm and thereby avoid overstressing the Darrieus Rotor or other components of the wind power station, e.g. of its generator. The radial direction of each wind deflector plate is defined by a vector pointing from the inner edge of the respective wind deflector plate to the rotor axis of the Darrieus rotor. The radial direction of a wind guide is defined by a vector pointing from the inner edge of the wind guide to the rotor axis of the wind guide.

In a further embodiment the wind concentrator includes sixteen wind guides. This number permits a good balance of wind collection and deflection on the one hand and slipstream effects on the other hand.

In a further embodiment the minimum distance between the rotor blade in rotation and each wind guide is between 0.05 and 0.25 times, preferably between 0.1 and 0.2 times, e.g. 0.16 times, the radius of the Darrieus Rotor. This distance yields an optimum torque gain of the wind concentrator.

In a further embodiment the extension of the wind guides in radial direction is between 0.2 and 0.65 times the radius of the Darrieus Rotor. This as well improves the torque gain. The extension of a wind guide in radial direction is considered as the length of the radial direction component of the vector from the outer edge of the wind guide to the inner edge of the wind guide.

In a further embodiment the wind concentrator includes optionally or as alternative to the wind guides at least one wind director. Preferably the wind concentrator includes more than one e.g. three or four wind directors. The wind director(s) is/are positioned in the cylinder defined by the inner perimeter of the rotating rotor blade(s). A wind director is a thin work piece with two wind guiding surfaces generated by parallel translation of the rotor axis along a template. The template may be a straight line or curved, e.g. an S-line curve. In the following it is assumed that the wind concentrator includes two or more wind directors. It is to be understood that the plural “wind directors” includes as well the singular, .i.e. “wind director”.

The wind directors reduce turbulences produced by the rotor blade passing the windward area of the Darrieus Rotor and thereby enhances the propulsion of the rotor blade(s) passing the leeward area of the Darrieus Rotor.

In a further embodiment the wind directors are configured to direct the flow such that the wind blows at the optimum angle, or at least closer to the optimum angle than without wind director, against the foil of the rotor blade when the rotor blade(s) pass(es) the leeward area of the Darrieus Rotor, thereby further enhancing its propulsion, i.e. the retractable torque at a given rotational speed, and thus the power. The leeward area is the area of the Darrieus Rotor enclosed by the leeward half of its perimeter. The windward area is defined accordingly as the area enclosed by the windward half of the perimeter of the Darrieus Rotor.

In a further embodiment the wind directors are adjustable e.g. pivotable according to the wind direction. To this end the wind directors are rotatably supported. The axis of rotation of the wind director may be identical to the axis of rotation of the Darrieus Rotor. The wind directors can be adjusted by a motor drive. Alternatively the wind director are self adjusting. To this end the centre of area of the wind directors can be positioned with an offset to the respective axis of rotation, e.g. the rotor axis.

In a further embodiment the wind power station includes a plurality of wind directors. At least two of the wind directors are connected by a base plate and/or a top plate. The base plate and/or the top plate are each preferably orthogonal to the rotor axis and/or parallel to the torque arms. The base and/or top plates reduce turbulences due to the torque arms and thereby enhance the torque produced by the wind on the rotor blades when the rotor blades pass the leeward area of the Darrieus Rotor.

### BRIEF DESCRIPTION OF THE DRAWINGS

In the following, the invention will be described by way of example, without limitation of the general inventive concept, on examples of embodiment and with reference to the drawings:

FIG. 1 shows a plan view of a wind power Station with a Darrieus Rotor,

FIG. 2 shows a side view of the wind power station of FIG. 1,

FIG. 3 shows a plan view of the wind power station of FIG. 1 with wind blowing from the south direction,

FIG. 4 shows a plan view of a wind power Station with a Darrieus Rotor,

FIG. 5 shows a plan view on a wind guide,

FIG. 6 shows a plan view on a wind guide,

FIG. 7 shows a plan view on a wind guide,

FIG. 8 shows a plan view on a wind guide,

FIG. 9 shows a plan view on a wind guide,

FIG. 10a, b show each a plan view of a wind guide,

FIGS. 11a, b show each a plan view of a wind guide,

FIG. 12 shows a plan view on a wind power station with wind directors,

FIG. 13 shows a cross section of the wind power station of FIG. 12 along plane A-A, and

FIG. 14 a plan view on a prior art wind power station.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE DRAWINGS

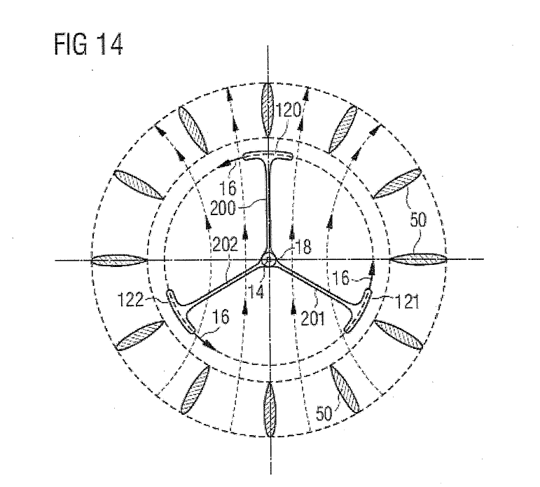

FIG. 14 shows a plan view of a prior art wind power station. The wind power station includes a Darrieus Rotor 10 with three rotor blades 120, 121 and 122. The rotor blades have the shape of a symmetric foil and are attached via torque arms 200, 201 and 202 to a shaft 18 and circle around a rotor axis 14. The direction of rotation is indicated by arrows 16. The shaft is coupled to a generator (not shown). The wind power station further includes a wind concentrator 40 of twelve wind guides 50. Each wind guide 50 has the shape of a symmetric foil. The tails of the wind guides 50 point towards the rotor axis 14. The wind guides 50 thus direct the wind towards the rotor axis 14. One may consider the arrangement of wind guides 50 as a “wind lens” focussing wind independent from its incident direction onto the rotor axis 14.

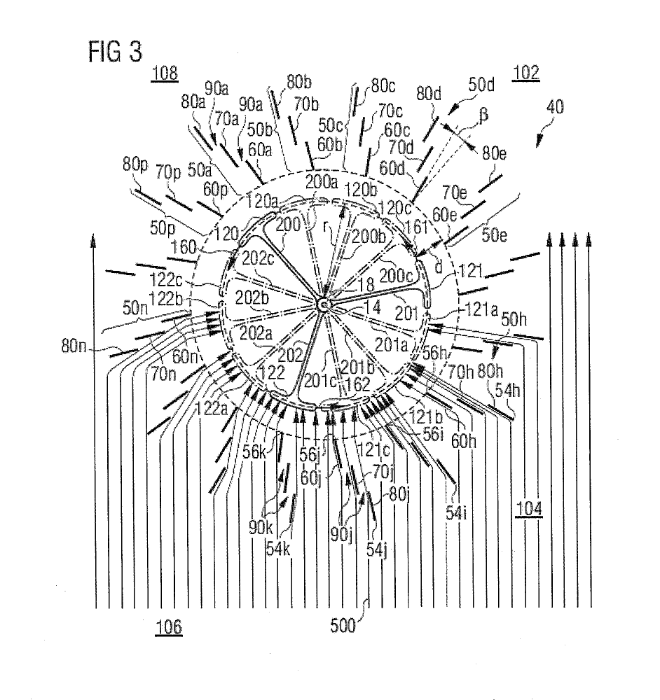

In the following some reference numerals have annexed letters, e.g. 50a, 50b, 50c, . . . 50p for the wind guides 50 (see e.g. FIG. 3). These letters (a, b, c, . . . p) permit to distinguish between identical parts that have different positions. The letters are omitted, if the respective positions of the otherwise identical parts are not considered in the context of the sentence. Newly introduced reference numerals are introduced as e.g. “channels 90 (90a to 90p)” to indicate that there are identical parts labelled “90a to 90p” referred to as 90, if the respective positions are not considered in the context of the sentence.

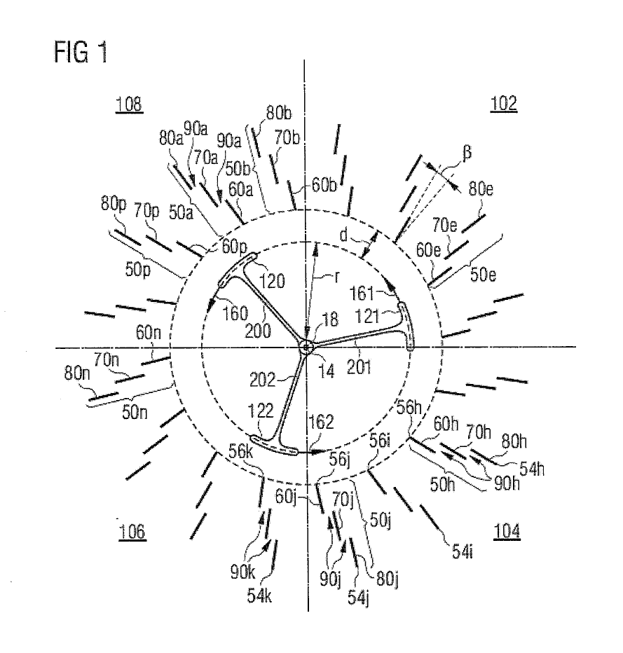

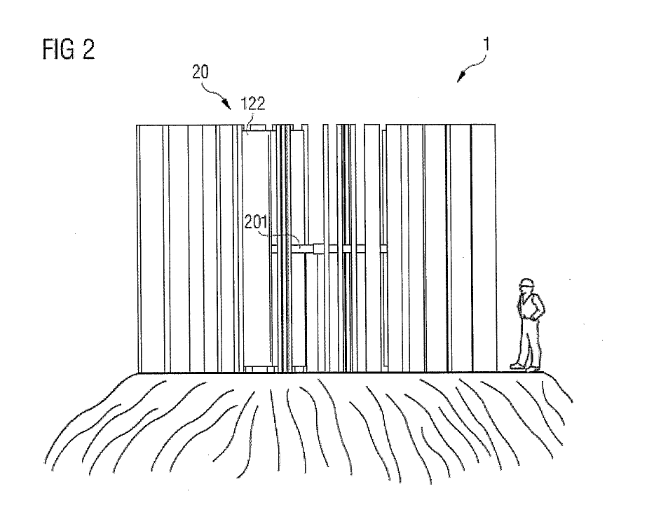

The wind power station 1 in FIGS. 1 to 3 as well includes a Darrieus Rotor 10 with three rotor blades 120, 121 and 122 (see FIG. 1). The rotor blades 120, 121 and 122 have a symmetric foil shape and are attached via torque arms 200, 201 and 202 to a shaft 18 and circle around a rotor axis 14. To improve the power retractable from the wind power station 1 at a given speed of wind, the wind power station 1 includes a wind concentrator 40 with sixteen wind guides 50 (50a to 50p). For clarity not all wind guides are labelled in the figures. The wind guides 50a to 50p are arranged concentrically to the rotor axis 14 and are evenly distributed around the Darrieus Rotor 10. The distance d between the Darrieus Rotor and the wind guides is about 0.1 times the radius r of the Darrieus Rotor. Each wind guide 50 (50a to 50p) includes three wind deflector plates 60, 70, 80 (60a, 70a and 80a to 60p, 70 and 80p). The wind deflector plates 60, 70 and 80 of each wind guide 50 are parallel to each other and equally spaced. The wind deflector plates 60, 70, 80 are arranged to let wind pass without deflection if the wind guide is positioned in the optimum slice, i.e. the wind deflection plates 60, 70 and 80 are inclined against the radial direction of the rotor blades 120, 121 and 122 in the position closest to the wind guide 50. The angle of inclination depends on the foil shape of the rotor blade and is preferably the above defined optimum angle. In this example the angle of inclination β is about 10° (typical values for β are between 2° and 20°, i.e. 2°≦β≦20°).

Between the wind deflector plates 60, 70, 80 of each wind guide 50 are channels 90 (90a to 90p) with a channel entry 94 (94a to 94p) and a channel exit 96 (96a to 96p); compare FIG. 5 to FIG. 9. If the wind enters parallel to the respective wind deflector plates 60, 70, 80 into the channels 90 the wind passes the respective wind guide 50 without being deflected. In case the wind enters the channels 90 under an angle, the wind is deflected by the wind deflector plates 60, 70, 80 essentially in their direction. In other words the wind is deflected in the respective optimum direction. In the example of FIG. 3 this is the case for the wind guides 50g to 50j in the south-east quadrant 104. If the wind blows against the wind guides 50 from a direction such that the channel entries 94 are in the leeward side of the respective wind deflector plates 70, 80, the wind guide 50 acts like wall or wind shield spanning from the most windward edge 54 of the wind guide 50 plates to the leeward edge 56 of the wind guide 50. In the example of FIG. 3 this is the case for the wind guides 50k to 50m in the south-west quadrant 106.

In FIG. 3 the rotor blades 120, 121, 122 are together with the correspond-ing torque arms shown in different positions 120a-120c, 121a-121c, 122a-122c, indicated by dashed-dotted lines. The wind 500 from the south direction (bottom) is symbolized by parallel arrows and deflected by the wind guides in the south west 106 and south east quadrant 104 towards the respective optimum direction. The shown deflection is for demonstrational purposes only and of course not in scale.

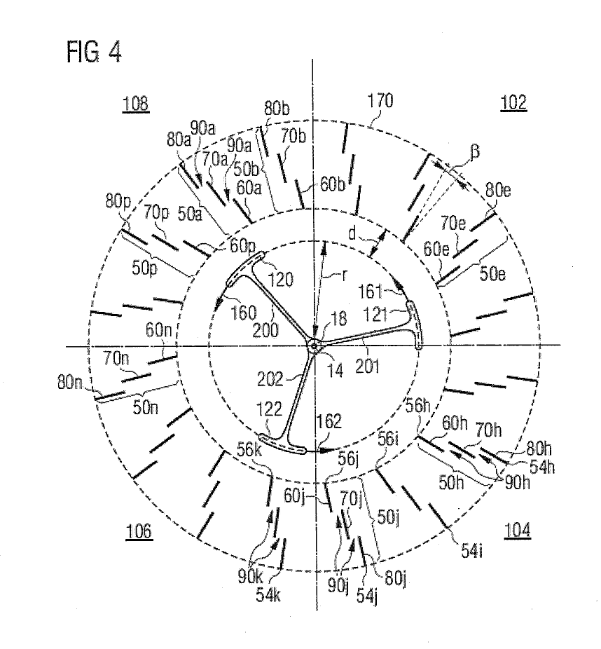

The wind power station in FIG. 4 is distinguishes over the wind power station of FIG. 1 to FIG. 3 only in that it further includes a wind protection shield. The wind protection shield includes a grid, e.g. like a wire mesh. Wind at low speed can pass the wind protection shield with essentially no slowing down of the wind. At higher wind speeds, however, the wind protection shield produces turbulences and slows the wind significantly down. Thus, the wind protection shield permits to protect other components of the wind power station, e.g. the Darrieus Rotor or the wind guides of being subjected to storm forces, i.e. wind speeds, outside the respective specifications that may cause damage. Further the wind protection shield may at the same time protect birds of being hit by the Darrieus Rotor.

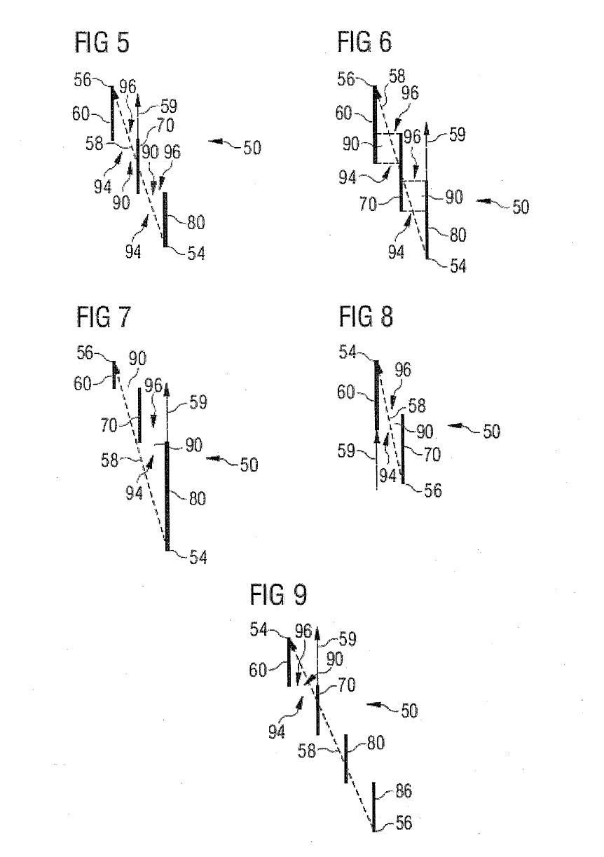

FIG. 5 is a plan view of a single wind guide 50 of the wind power stations 1 in FIG. 1 to FIG. 4. The wind guide includes three wind deflector plates 60, 70 and 80. The wind deflector plates 60, 70, 80 have the same size and are parallel to each other. The wind deflector plate 60 is the wind deflector plate of the wind guide 50 that is closest to the perimeter of the Darrieus Rotor (see FIG. 1), wind deflector plate 70 is the second closest wind deflector plate of the wind guide 50 and wind deflector plate 80 has the biggest distance to the perimeter of the Darrieus Rotor. In other words: the three wind deflector plates are parallel displaced. Between the wind deflector plates 60, 70 and 70, 80 are channels 90. The wind guide 50 has two directions of deflection, depending from which side the wind blows against the wind guide 50: The first direction of deflection is defined by the vector 58 from the windward edge 54 of the wind guide 50 to the leeward edge 56 of the wind guide. The vector 58 is shown as a dashed arrow. The second direction of deflection is parallel to the wind deflection plates 60, 70, 80 as indicated by the dotted vector 59. If the wind blows from a direction such that it can enter and pass through the channels 90, i.e. in the shown example from the left-bottom, the wind is deflected in the second direction defined by vector 59. If the wind blows against the wind guide 50 in a direction such that the channel entries 94 (compare FIG. 6) are in lee of the respective wind deflection plate 70, 80 the wind is deflected by the wind guide 50 in the first direction as indicated by vector 58.

FIG. 6 shows a wind guide 50, similar to the wind guide in FIG. 5. This wind guide 50 is an alternative to the wind guides shown in FIG. 1 to FIG. 5. It differs only in that the wind deflector plates 60, 70 and 80 are overlapping. Thus, the channels 90 have a longitudinal extension, i.e. channel entries 94 can be distinguished from channel exits 96, what is different from the situation in FIG. 1 to FIG. 5, where channel entries and the respective channel exits are identical. Compared to the wind guide of FIG. 5 turbulences are reduced due to the extension of the channels 90. On the other hand, however, the wind resistance due to friction is raised because the wind deflection plates 60, 70 and 80 are longer in the direction 59 in relation to the extension of the wind guide in the same direction. This wind guide 50 follows the same concept as the wind guides explained with reference to FIG. 1 to FIG. 5 and can be used instead. The same reference numerals denote the same details.

In FIG. 7 an alternative for the wind guides in FIG. 1 to FIG. 6 is shown. This wind guide 50 includes as well three wind deflector plates 60, 70, 80 being aligned in parallel. Wind deflector plate 60 has the shortest extension in direction of vector 59. Wind deflector plate 70 has an extension in direction 59 of about twice the respective extension of wind deflector plate 60. Wind deflector plate 80 has an extension in direction 59 of about twice the respective extension of wind deflector plate 70. This wind guide follows the same concept as the wind guides explained with reference to FIG. 1 to FIG. 6 and can be used instead. The same reference numerals denote the same details.

The wind guide 50 in FIG. 8 is a further alternative to wind guides in FIG. 1 to FIG. 7. This wind guide includes only two wind deflector plates 60 and 70. This wind guide is cheaper, but less efficient that the wind guides in shown in FIGS. 1 to 7.

The wind guide in FIG. 9 includes four wind deflector plates 60, 70, 80 and 86. The wind deflector plates 60, 70, 80, 86 are parallel displaced but have no overlap. The underlying functional principle of this wind guide is the same as of the wind guides in FIG. 1 to FIG. 5. The wind guide 50 may be used instead and the same reference numerals denote the same details. This wind guide permits a larger angle between the two different directions of deflection 58, 59 without enlarging the channel width.

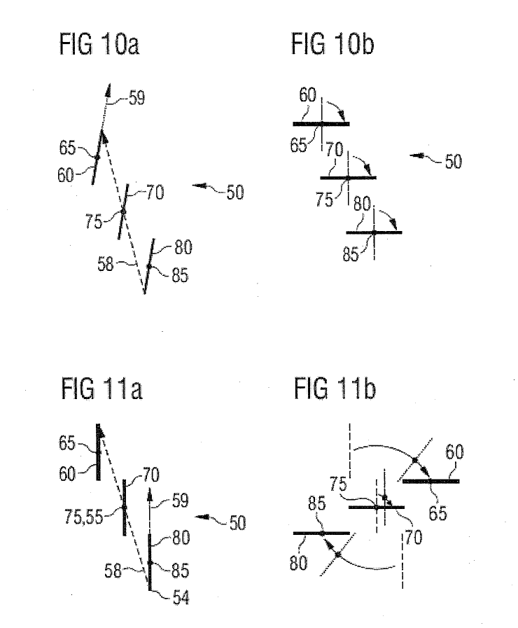

FIG. 10a shows a wind guide similar to the wind guide in FIG. 5, but the wind deflector plates 60, 70, 80 can be pivoted independently around axis 65, 75 and 85, respectively (the same reference numerals indicate the same detail). This permits to optimize the directions of deflection as a function of the wind direction. Further the wind deflector plates 60, 70, 80 can be turned to block the wind (see FIG. 10b, supposing south wind). This blocking function can be used to pre-vent damage of the Darrieus Rotor in case of wind overload

The wind guide in FIG. 11a provides a further degree of freedom to optimize the directions of deflection, because not only the wind deflector plates 60, 70, and 80 can be pivoted separately around axis 65, 75, and 85, but as well the whole wind guide can be pivoted around axis 55, being in this example identical to axis 75. In FIG. 11b the dashed lines indicate the positions of the wind deflector plates 60, 70, 80 in FIG. 11a. From these positions the wind guide was pivoted into a block position (full lines). Only for demonstration of the flexibility of the wind guide there are further indicated dotted positions of the wind deflector plates 60, 70, 80.

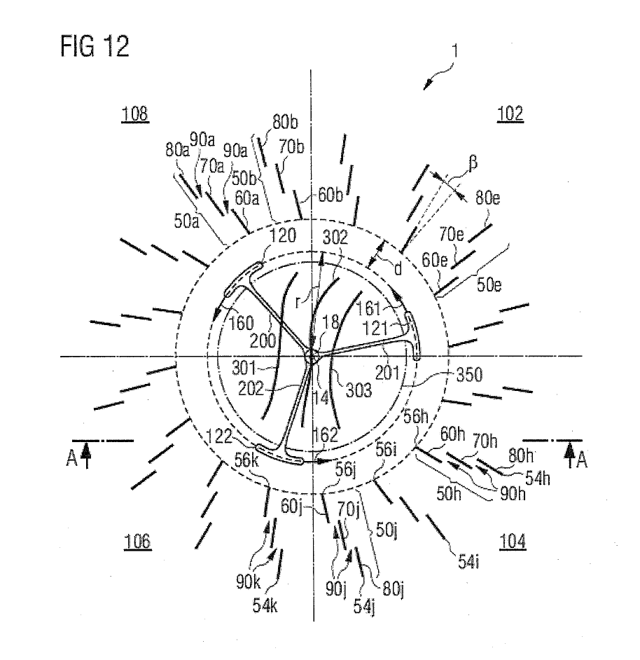

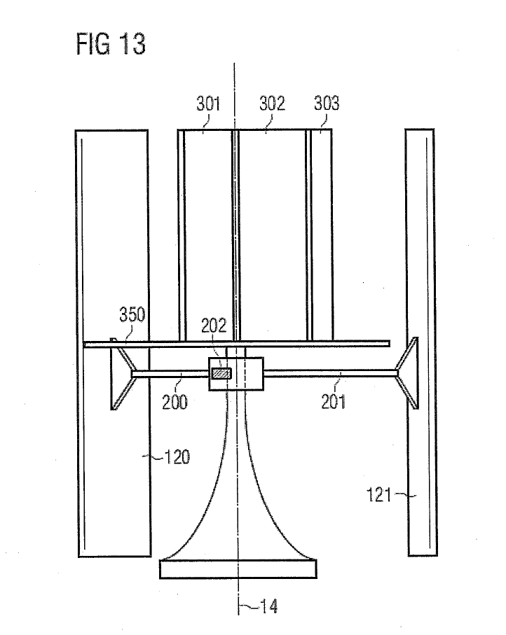

The wind power station of FIGS. 12 and 13 has all details of the wind power station in FIGS. 1 to 3, although the wind guides 50 are not shown in FIG. 13. Further the wind concentrator includes three wind directors 301, 302, 303. The wind directors 301, 302 and 303 are connected via a base plate 350. The base plate is parallel to the torque arms 200, 201, 202. The wind directors 301, 302, 303 and the base plate are rotatably supported and can rotate freely around the rotor axis 14. The part of the wind directors 301, 302, 303 that are windward of the axis of rotation generate a torque that is directed in the opposite direction of the torque exercised on the leeward part of the wind directors 301, 302, 303 (with respect to the axis of rotation). The wind directors 301, 302, 303 are configured such that the two torques are in balance if the wind directors 301, 302, 303 are in a position such that the wind leaving the channels 390 between the wind directors blows against the rotor blade at least almost at the optimum angle. For simplicity the windward area of the Darrieus Rotor 10 is the area in which the wind blows against the outer surface of the rotor blade. The leeward area is correspondingly the area in which the wind blows against the surface of the rotor blade which is directed towards the rotor axis (14). With respect to FIG. 3 the windward area is the area of the Darrieus Rotor enclosed by the windward, i.e. south half of the perimeter of the Darrieus Rotor, and the leeward area is the area enclosed by the leeward, i.e. north half of the perimeter of the Darrieus Rotor.

### DETAILED DESCRIPTION OF PREFERRED EMBODIMENTS

In an embodiment the wind power station 1 includes a Darrieus Rotor 10 with a rotor axis 14 and three rotor blade 120, 121, 122. Further the wind power station includes a wind concentrator 20. The wind concentrator 20 includes an assembly of sixteen wind guides 50 (50a to 50p) positioned around the Darrieus Rotor 10. Each wind guide 50 includes at least a first and a second wind deflector plate 60 (60a to 60p), 70 (70a to 70p), the first and the second wind deflector plates being parallel 60 (60a to 60p), 70 (70a to 70p). The following description assumes that all wind guides 50 each include at least two parallel wind deflector plates 60, 70. But of course one corresponding wind guide 50 is sufficient to enhance the retractable power.

The first and second wind deflector plates 60, 70 are parallel to the optimum direction. Thus, wind from the respective optimum direction passes the respective wind guide with low losses. Due to the channel(s) 90, (90a to 90p) between the wind deflector plates 60, 70, 80 turbulences are reduced, resulting in a higher torque. Further the wind guide has two different angles of deflection.

A first direction of deflection is defined by vector 58 from the most windward edge 54 of the wind deflector plates 60, 70, 80 to the most leeward edge 56 of the wind deflector plates 60, 70, 80 of the respective wind guide 50. The wind is deflected in this first direction of deflection if the wind hits the respective wind guide 50 such that the wind does not enter directly the channel 96 between the wind deflector plates 60, 70, 80 of the respective wind guide 50. Briefly speaking, the wind is deflected as if the wind guide 50 would be a single wall spanning from its windward edge 54 to its leeward edge 56, although the wind guide is an assembly of at least two wind deflector plates 60, 70, 80. If the wind, however, hits the respective wind guide 50 from the opposite site, i.e. such that it can enter into the channel 96 between the wind deflector plates 60, 70, 80, the direction of deflection is the direction of the vector 58 from the windward edge 54 to the respective leeward edge 56 of the respective wind deflector plate 60, 70, 80. This is the second direction of deflection 59. The two directions of deflection 58, 59 can thus be chosen and adjusted according to the foil profile of the rotor blades 120, 121, 122 by selecting the inclination of the wind deflector plates 60, 70, 80 against the radial direction on the one hand and the displacement of the wind deflector plates 60, 70, 80 in the radial direction together with the distance between the wind deflector plates 60, 70, 80.

The first wind deflector 60 plate is mounted closer to the rotor axis 14 then the second wind deflector plate 70.

The wind deflector plates 60, 70, 80 of the wind guides 50 have the same size. This helps to keep costs for the wind guides low.

In a further embodiment the wind deflector plates overlap, i.e. the distance from the outer edge of the first wind deflector plate 60 to the rotor axis is longer than the distance of inner edge of the second wind deflector plate 70 to the rotor axis. In the preferred embodiment the two distances have at least approximately the same length (see FIG. 1, 3, 4, 5, 9, 11a, 12).

The wind guides 50 are placed symmetrically around the rotor axis 14 to improve the retractable power from the wind power station 1 independent of the wind direction. There is no need to rotate the wind concentrator 20 to adjust it according to the wind direction.

The positions of the wind guides 50 are be fixed. This helps as well to keep costs low. Of course the wind guides can as well be rotatably supported, as shown in FIG. 10a, b and FIG. 11a, b.

The angle of inclination against the radial direction of at least a subset of the wind deflector plates may in a further embodiment as well be adjustable, e.g. by pivoting the wind deflector plates (see FIG. 10a,b and 11a,b). This permits to reduce the effective wind in case of storm and thereby avoid overstressing the Darrieus Rotor or other components of the wind power station, e.g. of a generator. The radial direction of each wind deflector plate is defined by a vector pointing form the inner edge of the respective wind deflector plate to the rotor axis of the Darrieus rotor. The radial direction of a wind guide is defined by a vector pointing from the inner edge of the wind guide to the rotor axis of the wind guide.

The number of 16 wind guides 50 permits a good balance of wind collection and deflection on the one hand and slipstream effects on the other hand.

The minimum distance between the rotor blade in rotation and the wind guides is preferably between 0.05 and 0.25 times, more preferably between 0.1 and 0.2 times, in the example of FIG. 1 0.16 times, the radius of the Darrieus Rotor. This distance yields an optimum torque gain of the wind concentrator.

The wind concentrator includes optionally or as alternative to the wind guides at least one wind director (see FIG. 12, 13). The wind concentrator includes wind directors 301, 302, 303. The wind directors 301, 302, 303 are positioned in the space defined by the inner perimeter of the rotating rotor blade 120, 121, 122. Each wind director 301,302, 303 is thin work piece with two wind guiding surfaces generated by parallel translation of the rotor axis along a S-curved template.

The wind directors 301, 302, 303 reduce turbulences produced by the rotor blade 120, 121, 122 passing the windward area of the Darrieus Rotor and thereby enhances the propulsion of the rotor blade(s) passing the leeward area of the Darrieus Rotor.

In a further embodiment the wind directors 301,302,303 are configured to direct the flow such that the wind blows at the optimum angle, or at least closer to the optimum angle than without wind directors against the foil of the rotor blade 120, 121, 122 when the rotor blades pass the leeward area of the Darrieus Rotor, thereby further enhancing its propulsion, i.e. the retractable torque at a given rotational speed and thus the power. The leeward area is the area of the Darrieus Rotor enclosed by the leeward half of its perimeter. The windward area is defined accordingly as the area enclosed by the windward half of the perimeter of the Darrieus Rotor.

The wind directors 301, 302, 303 are adjustable e.g. pivotable according to the wind direction. To this end the wind directors are rotatably supported. The axis of rotation of the wind director may be as well the axis of rotation 14 of the Darrieus Rotor 10. The wind directors 301, 302, 303 can be adjusted by a motor drive. Alternatively the wind director 301, 302, 303 are self adjusting. To this end the centre of area of the wind directors 301, 302, 303 can be positioned with an offset to the respective axis of rotation, e.g. the rotor axis 14.

In a further embodiment at least two of the wind directors are connected by a base plate 350 and/or a top plate. The base plate 350 and/or the top plate are each preferably orthogonal to the rotor axis 14 and/or parallel to the torque arms. The base 350 and/or top plates reduce turbulences due to the torque arms and thereby enhance the torque produced by the wind on the rotor blades if the rotor blades pass the leeward area of the Darrieus Rotor.

It will be appreciated to those skilled in the art having the benefit of this disclosure that this invention is believed to provide wind power stations, wind directors, wind concentrators and wind guides. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. Wind power station comprising:
a Darrieus Rotor having a rotor axis and at least one rotor blade mounted at a distance from said rotor axis, thereby defining a radius of said Darrieus Rotor;
a plurality of wind guides positioned around said Darrieus Rotor to form a wind concentrator,
wherein said wind guides comprise a first wind deflector plate and a second wind deflector plate, said first and said second wind deflector plates are mounted at least approximately parallel and configured to direct wind to said Darrieus Rotor.

2. Wind power station of claim 1, wherein said first wind deflector plates are mounted closer to said rotor axis than said second wind deflector plates.

3. Wind power station of claim 1, wherein:
said first wind deflector plate comprises a first edge mounted at a first distance from said rotor axis and a second edge mounted at a second distance from said rotor axis, said first distance being shorter than said second distance;
said second wind deflector plate comprises a third edge mounted at a third distance from said rotor axis, and a fourth edge mounted at a fourth distance from said rotor axis, said third distance being shorter than said fourth distance; and
said third distance is longer than said first distance and shorter than or equal to said second distance.

4. Wind power station of claim 1, wherein at least one of said first or second wind deflector plates has first edge and a second edge, said first and second edges being in a virtual plane, said virtual plane being parallel to said rotor axis.

5. Wind power station of claim 1, wherein said wind guides further comprise a least a third wind deflector plate, said third wind deflector plate being approximately parallel to said first and second wind deflector plates.

6. Wind power station of claim 1, wherein a minimum distance between said rotor blade in rotation and said wind guides is between 0.05 and 0.25 times said radius of said Darrieus Rotor.

7. Wind power station of claim 1, wherein said wind guides have an extension in radial direction, said extension in radial direction of said wind guide is between 0.2 and 0.65 times said radius of said Darrieus Rotor.

8. Wind power station comprising a Darrieus Rotor having a rotor axis and at least one rotor blade mounted at a distance from said rotor axis, thereby defining a radius of said Darrieus Rotor, wherein said wind power station further comprises at least one wind director positioned within a space defined by an inner perimeter of said rotor blade in rotation and wherein said wind director is configured to guide wind to said rotor blade passing a lee-ward area of said Darrieus Rotor.

9. Wind guide for a wind concentrator of a wind power station with a Darrieus Rotor wherein said wind guide comprises at least two approximately parallel spaced wind deflector plates.

10. Wind concentrator for a wind power station with a Darrieus Rotor wherein said wind concentrator comprises at least one wind guide, and at least one of said at least one wind guides comprises at least two parallel mounted wind deflector plates.

11. Wind director for a wind power station with a Darrieus Rotor having a rotor axis and at least one rotor blade mounted at a distance from said rotor axis, thereby defining a radius of said Darrieus Rotor, said wind director being configured to be mounted within a space defined by an inner perimeter of said rotor blade in rotation and to guide wind to said rotor blade passing a leeward area of said Darrieus Rotor.
